(19) United States
(12) Patent Application Publication
(10) Pub. No.: US 2010/0086783 A1
(43) Pub. Date: Apr. 8, 2010

(54) REDISPERSIBLE CORE-SHELL POLYMERS AND A PROCESS FOR PREPARING THEM

(75) Inventors: Oliver Schaefer, Burghausen (DE); Helmut Oswaldbauer, Stubenberg (DE); Christina Bauer, Simbach (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/527,101

(22) PCT Filed: Jan. 25, 2008
(86) PCT No.: PCT/EP08/50861

§ 371 Date: Aug. 13, 2009

(30) Foreign Application Priority Data
Feb. 14, 2007 (DE) 10 2007 007 336.6

(51) Int. Cl. C08L 83/06; B32B 27/08

(52) U.S. Cl. 428/407; 525/101

(57) ABSTRACT

Redispersible core/shell elastomeric particles are prepared by a process wherein a silicone elastomer core is covered with a second silicone shell, followed by an organic polymer shell.

The invention relates to elastomeric particulate core-shell copolymers, composed of an organopolysiloxane core polymer A, of a polydialkylsiloxane shell B, and of a shell D composed of organopolymer of monoolefinically unsaturated monomers, and to a process for their production.

Graft copolymers with core-shell structure, composed of an organosilicon polymer and of a graft chain which forms a shell around the rubber particle, and the production of these materials, are known from a number of publications, for example EP 1101799.

However, a disadvantage of all of the processes described is that the powders are generally produced by way of precipitation reactions, and the powders isolated therefore not only have a relatively high level of salt contamination but are also then incapable of complete redispersion in solvent, or organic resin systems, e.g. epoxy resins, or in thermoplastic polyesters.

Graft copolymers with core-shell structure which are redispersible in water or in aqueous systems are likewise known and are usually used for the modification of cementitious systems.

A disadvantage of the processes described here is likewise that said materials cannot be redispersed in organic media.

A solution was therefore sought to the problem of producing core-shell-polymer powders which are redispersible in organic media and are composed of an elastic core A, composed of an organosilicon polymer, and of an organopolymeric shell D, or, if appropriate, of two further inner shells B and C, where the inner shell B is composed of an organosilicon polymer and the shell C is composed of an organic polymer, and the polymers have a defined particle size.

It is preferable here that the rubber phase present in the core is a silicone rubber or a mixture of a silicone rubber with an organic rubber, e.g. with a diene rubber, fluororubber, or acrylate rubber, where the core must be composed of at least 40% by weight of a rubber phase. Particular preference is given here to a core which is composed of at least 50% of a silicone rubber.

DE 1595554 (U.S. Pat. No. 3,445,415) discloses a process for the production of aqueous graft copolymer latices, where unsaturated monomers are grafted onto organosiloxanes of the general formula RSiO3/2. A disadvantage of said process is that it can produce only hard polymers and cannot produce graft copolymers with elastomeric properties.

DE 2421288 (U.S. Pat. No. 3,898,300) describes a process method for the production of graft copolymers, where styrene and further monoethylenically unsaturated compounds are grafted onto a polyorganosiloxane graft base. To this end, mixtures of polyorganosiloxanes or mixtures of polyorganosiloxanes and of organosiloxanes are used as initial charge in emulsion, homogenized using homogenization equipment, and then grafted with the organic monomers.

This very complicated process method provides access only to polydisperse graft copolymer dispersions with broad particle-size distribution. Said process cannot produce graft copolymers with monomodal particle-size distribution and with particle sizes <0.1 micrometer.

DE-A 2539572 describes graft copolymers composed of organopolysiloxane and, respectively, silicone rubber, not defined in any further detail, and of vinyl and, respectively, acrylic monomers. High-speed agitator systems are used for the polymerization reaction. The product is polydisperse, with particle sizes from 1 to 3 mm.

DE-A 3629763 describes silicone rubber graft copolymers using vinyl and, respectively, acrylic monomers, where the silicone rubber phase is intended to have at least partial crosslinking. Although the mixture for production of the graft base is homogenized, the particle size of the graft base is 300 nm. The homogenization leads to a polydisperse particle-size distribution.

EP-A 231776 describes a mixture composed of polyester and polysiloxane graft copolymer. The polysiloxane is produced via emulsion polymerization of the monomeric silanes after homogenization using Ultraturrax or a homogenizer. The polysiloxane graft base is then grafted with vinyl monomer. The same method is used to produce the polyorganosiloxane graft copolymers described in U.S. Pat. No. 4,690,986. In the examples, the particle size of the graft copolymers is 300 nm; a polydisperse particle-size distribution is obtained, due to the homogenization process.

Particulate graft copolymers which have core-shell structure and which comprise polysiloxanes and, respectively, silicones, and which have more than one shell are described by way of example in EP-A 246537. In all cases, the siloxane and, respectively, silicone rubber graft base is produced after a homogenization step, and the consequence of this is a polydisperse particle-size distribution.

DE-A 3617267 and DE-A 3631539 describe a graft copolymer with a silicone rubber core, with a first shell composed of acrylate rubber, and with a grafted-on shell composed of monoethylenically unsaturated monomers.

EP-A 296402 relates to silicone rubber graft copolymers composed of a rubbery organopolymer core with a shell composed of organopolysiloxane, onto which ethylenically unsaturated monomers have been grafted.

All of these products lead to mono- or polydisperse silicone copolymers which sometimes also have an organic shell, and the distribution of which, as a function of the production method, is either mono- or polydisperse.

A disadvantage of said inventions is the fact that the silicone copolymers are present in aqueous dispersion and are obtained only when they are removed from said aqueous dispersion either by extraction or by precipitation in a non-solvent.

The solvent-silicone-copolymer mixtures obtained by extraction can, like aqueous dispersions, be treated directly by spray drying, giving fine-particle silicone copolymer powders. However, the procedures described in the literature show that both spray drying and precipitation lead to particle agglomerates which cannot then be completely redispersed during incorporation into an organic medium, e.g. a solvent. It is not possible to destroy these agglomerates, even by using high shear forces. A disadvantage of said agglomerates is that they lead to inhomogeneous distribution of the particles in the organic matrix, and this can lead to lack of transparency, for example. Furthermore, when these core-shell materials are used as impact modifiers, said agglomerates form points of weakness in the material, and these can lead to a reduction in impact resistance.

DE 4040986 A1 describes elastomeric graft copolymers which have a core composed of organosilicon polymer, an inner shell composed of polydialkylsiloxanes, and an outer shell composed of organic polymer.

DE 102004047708 A1 describes core-shell particles composed of an organopolysiloxane core polymer and of an acrylate copolymer shell, which have been reversibly agglomerated, and are dispersed in epoxy resin. However, only partial dispersion of the particles occurs, and some of the particles are very large.

Against this technological background, an object was to provide fine-particle polymers which are based on organosilicon polymers and on organic polymers, and which can in turn be easily redispersed in organic media. Said polymers should be accessible by way of a process which does not include any complicated mechanical emulsification and homogenization steps, and which can influence the particle size without using an additional emulsifier. The silicone copolymers should preferably be small and produced in monomodal distribution.

The invention provides elastomeric particulate core-shell copolymers, composed of

a) from 10 to 95% by weight, based on the total weight of the copolymer, of an organopolysiloxane core polymer A of the general formula (R₃SiO_{1/2})_{w}(R₂SiO_{2/2})ₓ.(R₁SiO_{3/2})_{y}. (SiO_{4/2})_{z}, where w=from 0 to 20 mol %, x=from 0 to 99.5 mol %, y=from 0.5 to 100 mol %, z=from 0 to 50 mol %,
b) from 0.02 to 30% by weight, based on the total weight of the copolymers, of a polydialkylsiloxane shell B composed of units of the formula (R₃SiO_{1/2})_{w}(R₂SiO_{2/2})ₓ.(R₁SiO_{3/2})_{y}.(SiO_{4/2})_{z}, where w=from 0 to 20 mol %, x=from 0 to 99.5 mol %, y=from 0.5 to 100 mol %, z=from 0 to 50 mol %,
c) from 0 to 89.45% by weight, based on the total weight of the copolymers, of a shell C composed of organopolymer of monoolefinically or polyolefinically unsaturated monomers,
and
d) from 0.05 to 89.5% by weight, based on the total weight of the copolymers, of a shell D composed of organopolymer of monoolefinically unsaturated monomers, where R are identical or different monovalent alkyl or alkenyl moieties having from 1 to 12 carbon atoms, aryl moieties, or substituted hydrocarbon moieties, and the average size of the particles is from 10 to 300 nm, and they have monomodal particle-size distribution,
with the proviso that, in the polydialkylsiloxane shell B, at least 5% of the moieties R have definitions which are selected from alkenyl moieties, acyloxyalkyl moieties, and mercaptoalkyl moieties.

The moieties R are preferably alkyl moieties, such as the methyl, ethyl, n-propyl, isopropyl, n-butyl, sec-butyl, amyl, hexyl moiety; alkenyl moieties, such as the vinyl and allyl moiety, and butenyl moiety; aryl moieties, such as the phenyl moiety; or substituted hydrocarbon moieties. Examples of these are halogenated hydrocarbon moieties, e.g. the chloromethyl, 3-chloropropyl, 3-bromopropyl, 3,3,3-trifluoropropyl, and 5,5,5,4,4,3,3-heptafluoropentyl moiety, and also the chlorophenyl moiety; mercaptoalkyl moieties, such as the 2-mercaptoethyl and 3-mercaptopropyl moiety; cyanoalkyl moieties, such as the 2-cyanoethyl and 3-cyanopropyl moiety; aminoalkyl moieties, such as the 3-aminopropyl moiety; acyloxyalkyl moieties, such as the 3-acryloxypropyl moiety and 3-methacryloxypropyl moiety; hydroxyalkyl moieties, such as the hydroxypropyl moiety. The moieties R preferably have at most 15 carbon atoms, in particular at most 10.

Particularly preferred moieties R are the moieties methyl, ethyl, propyl, phenyl, vinyl, 3-methacryloxy-propyl, 1-methacryloxymethyl, 1-acryloxymethyl, and 3-mercaptopropyl, and it is preferable here that at most 30 mol % of the moieties in the siloxane polymer are vinyl, 3-methacryloxypropyl, or 3-mercaptopropyl groups.

Monomers used for the shells D and, if appropriate, C, composed of organopolymer, are preferably acrylic esters or methacrylic esters of aliphatic alcohols having from 1 to 10 carbon atoms, acrylonitrile, styrene, p-methylstyrene, alpha-methylstyrene, vinyl acetate, vinyl propionate, maleimide, vinyl chloride, ethylene, butadiene, isoprene, and chloroprene, or difunctional moieties, such as allyl methacrylate. Particular preference is given to styrene, and also acrylic esters and methacrylic esters of aliphatic alcohols having from 1 to 4 carbon atoms, such as methanol, ethanol, propanol, examples being methyl methacrylate, ethyl methacrylate, methyl acrylate, ethyl methacrylate, glycidyl methacrylate, butyl acrylate, or butyl methacrylate. Both homopolymers and copolymers of the monomers mentioned are suitable as organic polymer fraction.

The average particle size (diameter) of the core-shell copolymers is preferably at least 20 nm, in particular at least 40 nm, and at most 250 nm, in particular at most 200 nm, measured by a transmission electron microscope.

The particle-size distribution is highly uniform, and the core-shell copolymers are monomodal, meaning that the particles have one particle-size-distribution maximum, and have a polydispersity factor, sigma 2, of at most 0.5, measured by a transmission electron microscope.

The particle size and the polydispersity index sigma 2 are determined by a transmission electron microscope: the transmission electron microscope and the attached computer unit are used to determine the curves for diameter distribution, surface-area distribution, and volume distribution, for each of the specimens. The average value for particle size, and its standard deviation sigma, can be determined from the diameter-distribution curve. The average value for the average volume V is obtained from the surface-area-distribution curve. The average value for the average surface area A of the particles is obtained from the surface-area-distribution curve. The polydispersity index sigma 2 can be calculated by using the following formulae:

sigma 2=sigma/x3/2, where x3/2=V/A

According to P. Becher (Encyclopedia of Emulsion Technology, vol. 1, page 71, Marcel Dekker, New York 1983) a particle-size distribution is monomodal when the polydispersity index sigma 2 calculated from the abovementioned formula is smaller than 0.5. This is the definition used here.

The maximum value of the polydispersity index of the core-shell copolymers is preferably sigma 2=0.3, in particular sigma 2=0.2.

The glass transition temperature of the shell D is preferably from 60 to 145° C., very particularly preferably from 75 to 130° C.

The glass transition temperature of the organopolysiloxane core polymer A is preferably from −60 to −150° C., very particularly preferably from −75 to −140° C.

The core A serving as graft base, with the polydialkylsiloxane shell B, is preferably produced by the known emulsion polymerization process, by feed of from 0.05 to 95% by weight, based on the total weight of the graft copolymer to be produced, of a monomeric silane of RSi(OR′)₃ type, or feed of a mixture of monomeric silanes of [RₐSi (OR′)4-a], type, where a=0, 1, or 2, and n can have a value of from 3 to 6, into a moving emulsifier/water mixture. The definitions for the moiety R are those mentioned above. R′ is defined as alkyl moieties having from 1 to 6 carbon atoms, aryl moieties, or substituted hydrocarbon moieties preferably having from 2 to 20 carbon atoms, preference being given to methyl, ethyl, and propyl moiety. It is possible to use hydrophilic seed latices.

Particularly suitable emulsifiers are carboxylic acids having from 9 to 20 carbon atoms, aliphatically substituted benzenesulfonic acids having at least 6 carbon atoms in the aliphatic substituents, aliphatically substituted naphthalenesulfonic acids having at least 4 carbon atoms in the aliphatic substituents, aliphatic sulfonic acids having at least 6 carbon atoms in the aliphatic moieties, silylalkylsulfonic acids having at least 6 carbon atoms in the alkyl substituents, aliphatically substituted diphenyl ether sulfonic acids having at least 6 carbon atoms in the aliphatic moieties, alkyl hydrogensulfates having at least 6 carbon atoms in the alkyl moieties, quaternary ammonium halides or quaternary ammonium hydroxides. All of the acids mentioned can be used as they stand or, if appropriate, in a mixture with their salts. If anionic emulsifiers are used, it is advantageous to use those whose aliphatic substituents contain at least 8 carbon atoms. Preferred anionic emulsifiers are aliphatically substituted benzenesulfonic acids. If cationic emulsifiers are used, it is advantageous to use halides. The amount to be used of emulsifier is from 0.1 to 20.0% by weight, preferably from 0.2 to 3.0% by weight, based in each case on the amount used of organosilicon compounds.

The silane or the silane mixture is preferably added in metered form. The emulsion polymerization reaction is carried out at a temperature of from 30 to 90° C., preferably from 60 to 85° C., and preferably at atmospheric pressure. The pH of the polymerization mixture is preferably from 1 to 4, in particular from 2 to 3.

The polymerization reaction for production of the graft base can be carried out either continuously or else batchwise; it is preferably carried out batchwise.

In the case of a continuous procedure, the residence time in the reactor is preferably from 30 to 60 minutes. In the case of batchwise production of the graft base, it is advantageous for the stability of the emulsion that stirring is continued for from 0.2 to 5.0 hours after metering has ended. In one preferred embodiment, for a further improvement in the stability of the polysiloxane emulsion, distillation is used to remove the alcohol liberated during the hydrolysis reaction, especially when there is a high proportion of silane of the general formula RSi(OR′)₃.

The first reaction step uses a composition having one or more components, composed of from 0 to 99.5 mol % of a silane of the general formula R₂Si (OR′)₂, or of an oligomer of the formula (R₂SiO)ₙ, where n=from 3 to 8, from 0.5 to 100 mol % of a silane of the general formula RSi(OR′)₃, and from 0 to 50 mol % of a silane of the general formula Si(OR′)₄, where the mol % data are in each case based on the overall composition of the graft base.

The preferred amounts of feed in the first reaction step are from 0.5 to 10 mol % of silanes of the general formula RSi(OR′)₃, and preferably from 0 to 50 mol %, in particular from 0 to 10 mol %, of silanes of the general formula Si(OR′)₄, where the mol % data are in each case based on the overall composition of the graft base.

Examples of silanes of the general formula R₂Si (OR′)₂ are dimethyldiethoxysilane or dimethyldimethoxysilane. Examples of oligomers of the formula (R₂SiO)ₙ, where n=from 3 to 8 are decamethylcyclopentasiloxane, octamethylcyclotetrasiloxane, or hexamethylcyclotrisiloxane.

Examples of silanes of the general formula RSi(OR′)₃ are methyltrimethoxysilane, phenyltriethoxysilane, vinyl-trimethoxysilane, 3-chloropropyltrimethoxysilane, 3-mercaptopropyltrimethoxysilane, or 3-methacryloxy-propyltrimethoxysilane.

Examples of silanes of the general formula Si(OR′)₄ are tetramethoxysilane or tetraethoxysilane.

Prior to grafting-on of the monoethylenically unsaturated monomers, the graft base is grafted with the organosilicon shell polymer B. Said shell B is likewise preferably produced by the emulsion polymerization process. The process uses feed of functional silanes of the general formula RSi(OR′)₃, or functional silanes of the general formula R₂Si(OR′)₂, or low-molecular-weight siloxanes of the general formula (R₂SiO)ₙ, where n=from 3 to 8, into the moving emulsion of the graft base. The moieties R and R′ here have the abovementioned definitions. It is preferable that no further emulsifier is added, since the amount of emulsifier present in the emulsion of the graft base is sufficient for stabilization.

The polymerization reaction for grafting-on of the shell B is preferably carried out at a temperature of from 15 to 90° C., in particular from 60 to 85° C., and preferably at atmospheric pressure. The pH of the polymerization mixture is preferably from 1 to 4, in particular from 2 to 3. This reaction step, too, can be carried out either continuously or batchwise. The residence times in the reactor for a continuous embodiment, or the continued-stirring times in the reactor for a batchwise embodiment, depend on the amount of feed of silanes or siloxanes, preferably being from 2 to 6 hours. In the most advantageous method, the reaction steps for the production of the graft base A and of the shell polymer B are combined in a suitable reactor and, if appropriate, distillation is finally used to remove the alcohol formed.

The amounts of feed of the functional silanes of the general formula RSi(OR′)₃ or R₂Si(OR′)₂, or low-molecular-weight siloxanes of the general formula (R₂¹SiO_{2/2})ₙ, where n=from 3 to 8 are such that the proportion of organosilicon shell polymer B is from 0.2 to 30% by weight, preferably from 1 to 15% by weight, based on the total weight of the particulate graft copolymer.

The solids content of the resultant siloxaneelastomersols should preferably be at most 35% by weight, either without or with organosilicon shell polymer B since otherwise a large rise in viscosity makes it difficult to process the sols further in the form of graft base.

If appropriate, for application of the inner shell C, the abovementioned monomers which are selected from mono- and polyethylenically unsaturated monomers are then grafted onto the polysiloxane graft base grafted with the organosilicon shell polymer B. To this end, the amount of feed of the organic monomers is preferably from 0.5 to 40% by weight, with preference from 1 to 15% by weight, based in each case on the total weight of the graft copolymer. The grafting preferably takes place by the emulsion polymerization process in the presence of water-soluble or monomer-soluble free-radical initiators. Suitable free-radical initiators are water-soluble peroxocompounds, organic peroxides, hydroperoxides, or azo compounds. It is particularly preferable to use, for example, K₂S₂O₈ and KHSO₃ to initiate the redox catalysis. The amount preferably used here of oxidation component and reduction component is from 0.01 to 2% by weight, based on the amount of monomer.

Examples of suitable monomers are allyl methacrylate, triallyl cyanurate, triallyl isocyanurate, diallyl phthalate, ethylene glycol dimethacrylate, butylene 1,3-glycol dimethacrylate, and divinylbenzene. The reaction temperatures depend on the nature of the initiator used, and are preferably from 15 to 90° C., in particular from 30 to 85° C. In order to avoid hydrolysis, particularly in the case of ester-functional monomers, the pH should preferably be adjusted to from 4 to 6. In this reaction step, too, it is preferable to avoid feed of any further emulsifier, in addition to the emulsifier added in the first stage. An excessive concentration of emulsifier can lead to solubilizate-free micelles, which can function as nuclei for purely organic latex particles. This reaction step, too, can be carried out either continuously or batchwise.

In the final step of the production process, the abovementioned monoethylenically unsaturated monomers are grafted onto the polysiloxane graft base preferably grafted with the inner shell C. To this end, the amount of feed of the organic monomers is preferably from 5 to 85% by weight, preferably from 10 to 50% by weight, based in each case on the total weight of the graft copolymer. The grafting preferably takes place by the emulsion polymerization process in the presence of water-soluble or monomer-soluble free-radical initiators. Suitable free-radical initiators are water-soluble peroxo compounds, organic peroxides, hydroperoxides or azo compounds. It is particularly preferable to initiate the redox catalysis with K₂S₂O₈ and KHSO₃, for example. The amount preferably used of oxidation component and reduction component here is from 0.01 to 2% by weight, based on the amount of monomer.

The reaction temperatures depend on the nature of the initiator used and are preferably from 15 to 90° C., in particular from 30 to 85° C. In order to avoid hydrolysis, particularly when using ester-functional monomers, the pH should preferably be adjusted to from 4 to 6. It is again preferable in this reaction step to avoid feed of any further emulsifier in addition to the emulsifier added in the first stage. An excessive concentration of emulsifier can lead to solubilizate-free micelles, which can function as nuclei for purely organic latex particles. This reaction step, too, can be carried out either continuously or batchwise.

Known processes can be used to isolate the particulate graft copolymers from the emulsion. Isolation from aqueous dispersion by spray drying is particularly preferred.

This spray drying takes place in conventional spray-drying systems, possible methods of atomization being single-, twin-, or multifluid nozzles, or a rotating disk. The discharge temperature is generally selected in the range from 55° C. to 150° C., preferably from 70° C. to 90° C., depending on the system, on the T(g) of the copolymer, and on the desired degree of drying.

The average particle size of the resultant powders is preferably from 10 to 200 μm, very particularly preferably from 25 μm to 170 μm. These powders are simply agglomerates composed of small primary particles respectively having an average particle size in a range which is preferably from 10 to 300 nm.

Using the procedure of the invention, particle size can be influenced not only by way of emulsifier content but also by way of reaction temperature and pH, and especially by way of the constitution of the particulate graft copolymers. Introduction of an organosilicon shell b) provides improved coupling of the organopolymer shell phase c) or d) to the organosilicon graft base. The result is that the particulate graft copolymers are readily redispersible in organic media at low temperatures, for example from 20 to 60° C.

The particulate graft copolymers are particularly suitable for application in the form of modified thermoplastics or for use as additives for polymer modification. Here, they particularly improve impact resistance and processing performance, and also improve non-flammability. If the particulate graft copolymers are used per se as elastomeric thermoplastics, the content of elastomeric polysiloxane should be no more than 40% by weight. The particulate graft copolymers moreover exhibit or bring about improved mechanical properties, for example weathering and ageing resistance, thermal stability, notched impact resistance, and low-temperature toughness.

Each of the definitions of all of the above symbols in the above formulae is independent of the others.

The silicon atom in all of the formulae is tetravalent.

Unless otherwise stated, all quantitative and percentage data are based on weight, all pressures are 0.10 MPa (abs.), and all temperatures are 20° C.

### EXAMPLE 1

### Not of the Invention

### Production of Graft Base:

3800 g of water and 19 g (1.9% by weight, based on Si compounds) of dodecylbenzenesulfonic acid were heated to 85° C. The feed comprised a mixture composed of 855 g (2.9 mol, 74 mol %) of octamethylcyclotetrasiloxane, 97 g (0.7 mol, 18 mol %) of methyltrimethoxysiloxane, and 66 g (0.3 mol, 8 mol %) of methacryloxypropyltrimethoxysilane, and stirring was continued at 85° C. for 4 hours. Removal of about 400 g of distillate gave a dispersion with 21% by weight solids content and particle size 111 nm.

### Grafting:

1350 g of the dispersion were inertized with nitrogen in a 15 l reactor and adjusted to pH 4. The first feed comprised 90 g of methyl methacrylate, and polymerization was initiated by adding 5.2 g (0.6% by weight, based on monomer) of K₂S₂O₈ and 18 g (2.1% by weight, based on monomer) of NaHSO₃ (37% by weight in water). The second feed, within a period of one hour, comprised a further 780 g of methyl methacrylate, and this was followed by heating to 65° C., the polymerization reaction being completed within 3 hours. This gave a latex with 24% by weight of polymethyl methacrylate in the graft copolymer and with 26.7% by weight solids content, average particle size 127 nm, and polydispersity index sigma 2=0.02.

### EXAMPLE 2

### Not of the Invention

### Production of Graft Base:

91.8 g (0.7 mol, 88 mol %) of methyltrimethoxysilane and 17.2 g (0.1 mol, 12 mol %) of tetraethoxysilane were added dropwise at 80° C. within a period of 2 hours to 950 g of water and 1.0 g (0.9% by weight, based on Si compound) of dodecylbenzenesulfonic acid, and stirring was continued for 30 minutes.

### Grafting of Shell B:

The temperature was then increased to 90° C., and the feed, within a period of 1.5 hours, comprised 80 g of octamethylcyclotetrasiloxane, and also 18 g of 10% strength dodecylbenzenesulfonic acid in water; stirring was continued for 3.5 hours and the product was distilled to initial volume. This gave a hydrosol with 12.7% solids content and average particle size 36 nm.

### Grafting of Shell D:

800 g of the hydrosol were adjusted to pH 5 using sodium carbonate solution and saturated with nitrogen. After addition of 3 g of freshly washed methyl methacrylate, the reaction was initiated by adding 0.04 g (0.13% by weight, based on monomer) of K₂S₂O₈ and 0.05 g (0.16% by weight, based on monomer) of NaHSO₃ (37% by weight in water), and the feed, within a period of 30 minutes, then comprised a further 27.5 g of methyl methacrylate, and this was followed by heating to 65° C., the polymerization reaction being completed within a period of 3 hours. This gave a latex with 23% by weight of polymethyl methacrylate in the graft copolymer and with 17% by weight solids content, average particle size 50 nm, and polydispersity index sigma 2=0.02.

### EXAMPLE 3

### Of the Invention

### Production of Graft Base:

3000 g of water, 5 g (0.5% by weight, based on Si compounds) of dodecylbenzenesulfonic acid, and 8 g of acetic acid were heated to 90° C. The feed, within a period of 2 hours, comprised a mixture composed of 855 g (92 mol %) of octamethylcyclotetrasiloxane and 95 g (5 mol %) of vinyltrimethoxysiloxane, and stirring was continued for 3 hours.

### Grafting of Shell B

The feed then comprised 63 g (2 mol %) of methacryloxypropyltrimethoxysilane, and stirring was continued at 90° C. for 1 hour. This gave a dispersion with 23% by weight solids content and average particle size 132 nm.

### Grafting of Shell D:

13 050 g of the dispersion were inertized with nitrogen in a 15 l reactor and adjusted to pH 4. The first feed comprised 90 g of methyl methacrylate, and the polymerization reaction was initiated by adding 5.2 g (0.6% by weight, based on monomer) of K₂S₂O₈ and 18 g (2.1% by weight, based on monomer) of NaHSO₃ (37% by weight in water). The second feed, within a period of one hour, comprised a further 780 g of methyl methacrylate, and this was followed by heating to 65° C., the polymerization reaction being completed within a period of 3 hours. This gave a latex with 24% by weight of polymethyl methacrylate in the graft copolymer and with 26.7% by weight solids content, average particle size 127 nm, and polydispersity index sigma 2=0.02.

### EXAMPLE 4

### Of the Invention

### Production of Graft Base:

3000 g of water, 5 g (0.5% by weight, based on Si compounds) of dodecylbenzenesulfonic acid, and 8 g of acetic acid were heated to 90° C. The feed, within a period of 2 hours, comprised a mixture composed of 855 g (92 mol %) of octamethylcyclotetrasiloxane and 95 g (5 mol %) of vinyltrimethoxysilane, and stirring was continued for 3 hours.

### Grafting of Shell B

The feed then comprised 63 g (2 mol %) of methacryloxypropyltrimethoxysilane, and stirring was continued at 90° C. for 1 hour. This gave a dispersion with 23% by weight solids content and average particle size 132 nm.

### Grafting of Shell D:

13 050 g of the dispersion were inertized with nitrogen in a 15 l reactor and adjusted to pH 4. The first feed comprised 90 g of methyl methacrylate, and the polymerization reaction was initiated by adding 5.2 g (0.6% by weight, based on monomer) of K₂S₂O₈ and 18 g (2.1% by weight, based on monomer) of NaHSO₃ (37% by weight in water). The second feed, within a period of one hour, comprised a mixture composed of a further 700 g of methyl methacrylate and 90 g of glycidyl methacrylate, and this was followed by heating to 65° C., the polymerization reaction being completed within a period of 3 hours. This gave a latex with 24% by weight of polymethyl methacrylate in the graft copolymer and with 26.4% by weight solids content, average particle size 121 nm, and polydispersity index sigma 2=0.03.

### EXAMPLES 5-8

### Isolation of Core-Shell Materials by Spray Drying

The dispersions produced in examples 1-4 were sprayed from aqueous dispersion. The dispersion here was sprayed through a single-fluid nozzle in a spray-drying tower from Nubilosa (height 12 m, diameter 2.2 m), using a pressure of 33 bar. The input temperature was 145° C. and the discharge temperature was 75° C., and the dispersions here had been preheated to 55° C. Throughput was 65 l of dispersion per hour, and the amount of drying air was 2000 m³/h.

All 3 dispersions gave pulverulent products.

| | Example | Example | | |
|---|---|---|---|---|
| | 5* | 6* | Example 7 | Example 8 |
| Dispersion used | Example 1 | Example 2 | Example 3 | Example 4 |
| Amount of | 300 kg | 300 kg | 300 kg | 300 kg |
| dispersion | | | | |
| Amount of powder | 72 kg | 48 kg | 74 kg | 3 kg |
| Glass transition | −115° C. | not | −115° C. | −115° C. |
| temperature of | | determined | | |
| core | | | | |
| Glass transition | 96° C. | not | 94° C. | 91° C. |
| temperature of | | determined | | |
| shell | | | | |
| Average particle | 67 μm | 58 μm | 43 μm | 35 μm |
| size | | | | |

*not of the invention

### Performance Testing:

### EXAMPLES 9-20

The powders obtained in examples 5-8 were incorporated by mixing into various solvents and stirred overnight. After 16 hours of stirring time, the product was then filtered off using a paper filter, and dried. Finally, the solids content of the filtrate was determined.

| | Example | Example | | |
|---|---|---|---|---|
| | 9* | 10* | Example 11 | Example 12 |
| Powder used | Example 5 | Example 6 | Example 7 | Example 8 |
| Amount of THF | 90 g | 90 g | 90 g | 90 g |
| Amount of powder | 10 g | 10 g | 10 g | 10 g |
| Theoretical | 10% | 10% | 10% | 10% |
| solids content | | | | |
| (100% | | | | |
| redispersion) | | | | |
| Appearance of | white, | white, | translucent, | translucent, |
| mixture | sediment | sediment | no sediment | no sediment |
| Solids content of | 0.5% | 0.6% | 9.9% | 9.5% |
| filtrate | | | | |
| Redispersion | 5% | 6% | 99% | 95% |

*not of the invention

| | Example | Example | | |
|---|---|---|---|---|
| | 13* | 14* | Example 15 | Example 16 |
| Powder used | Example 5 | Example 6 | Example 7 | Example 8 |
| Amount of toluene | 90 g | 90 g | 90 g | 90 g |
| Amount of powder | 10 g | 10 g | 10 g | 10 g |
| Theoretical | 10% | 10% | 10% | 10% |
| solids content | | | | |
| (100% | | | | |
| redispersion) | | | | |
| Appearance of | white, | white, | translucent, | translucent, |
| mixture | sediment | sediment | no sediment | no sediment |
| Solids content of | 0.7% | 0.6% | 9.8% | 9.6% |
| filtrate | | | | |
| Redispersion | 7% | 6% | 98% | 96% |

*not of the invention

| | Example | Example | | |
|---|---|---|---|---|
| | 17* | 18* | Example 19 | Example 20 |
| Powder used | Example 5 | Example 6 | Example 7 | Example 8 |
| Amount of MIBK | 90 g | 90 g | 90 g | 90 g |
| Amount of powder | 10 g | 10 g | 10 g | 10 g |
| Theoretical | 10% | 10% | 10% | 10% |
| solids content | | | | |
| (100% | | | | |
| redispersion) | | | | |
| Appearance of | white, | white, | translucent, | translucent, |
| mixture | sediment | sediment | no sediment | no sediment |
| Solids content of | 0.6% | 0.5% | 9.9% | 9.4% |
| filtrate | | | | |
| Redispersion | 6% | 5% | 99% | 94% |

*not of the invention

The redispersibility of the powders of the invention is above 80%.

The translucency of the resultant solutions also provides clear optical evidence of complete redispersion, clearly demonstrating that redispersion breaks the powder agglomerates down into their primary particles.

The powders not of the invention generally exhibit much poorer redispersibility.

Particle size and polydispersity index were determined using a transmission electron microscope from Phillips (Phillips CM 12) and an evaluation unit from Zeiss (Zeiss TGA 10). The latex to be measured was diluted with water and applied using a 1 μl inoculation loop to a standard copper gauze.

1.-9. (canceled)

10. An elastomeric particulate core-shell copolymer, comprising:
a) from 10 to 95% by weight, based on the total weight of the copolymer, of an organopolysiloxane core polymer A of the formula
(R₃SiO_{1/2})_{w}(R₂SiO_{2/2})ₓ.(R₁SiO_{3/2})_{y}.(SiO_{4/2})_{z}, where w=from 0 to 20 mol %, x=from 0 to 99.5 mol %, y=from 0.5 to 100 mol %, z=from 0 to 50 mol %,
b) from 0.02 to 30% by weight, based on the total weight of the copolymer, of a polydialkylsiloxane shell B composed of units of the formula
(R₃SiO_{1/2})_{w}(R₂SiO_{2/2})ₓ.(R₁SiO_{3/2})_{y}. (SiO_{4/2})_{z}, where w=from 0 to 20 mol %, x=from 0 to 99.5 mol %, y=from 0.5 to 100 mol %, z=from 0 to 50 mol %,
c) from 0 to 89.45% by weight, based on the total weight of the copolymer, of a shell C composed of organopolymer of monoolefinically or polyolefinically unsaturated monomers, and
d) from 0.05 to 89.5% by weight, based on the total weight of the copolymer, of a shell D composed of organopolymer of monoolefinically unsaturated monomers,
where R are identical or different monovalent alkyl or alkenyl moieties having from 1 to 12 carbon atoms, aryl moieties, or substituted hydrocarbon moieties,
wherein the average size of the particles is from 10 to 300 nm, and they have monomodal particle-size distribution,
with the proviso that, in the polydialkylsiloxane shell B, at least 5% of the moieties R are alkenyl moieties, acyloxyalkyl moieties, mercaptoalkyl moieties, or mixtures thereof.

11. The elastomeric copolymer of claim 10, in which the average particle size is at most 200 nm.

12. The elastomeric copolymer of claim 10, wherein the glass transition temperature of the organopolysiloxane core polymer A is from −60 to −140° C.

13. The elastomeric copolymer of claim 10, wherein the glass transition temperature of the shell D is from 60 to 140° C.

14. A process for the production of an elastomeric copolymer of claim 10, wherein
in a first reaction step, in an emulsion polymerization process, from 0 to 99.5 mol % of a silane of the formula R₂Si(OR′)₂ or of an oligomer of the formula (R₂SiO)ₙ, where n=from 3 to 8, from 0.5 to 100 mol % of a silane of the formula RSi(OR′)₃, and from 0 to 50 mol % of a silane of the formula Si(OR′)₄ are reacted to form an organopolysiloxane core polymer A, and,
in a second reaction step, in an emulsion polymerization process, functional silanes which are selected from silanes of the formula RSi(OR′)₃, functional silanes of the formula R₂Si(OR′)₂, and low-molecular-weight siloxanes of the formula (R₂SiO)ₙ, where n=from 3 to 8 are fed into the moving emulsion of the organopolysiloxane core polymer A in an amount such that the proportion of polydialkylsiloxane shell polymer B is from 0.02 to 30% by weight, based on the total weight of the polymer, and,
in a third reaction step, in an emulsion polymerization process, ethylenically unsaturated monomers are fed into the organopolysiloxane core polymer A with a shell composed of polydialkylsiloxane polymer B in an amount such that the proportion of the shell D composed of organopolymer of monoolefinically unsaturated polymers D is from 0.05 to 89.5% by weight, based on the total weight of the polymer,
where R are identical or different monovalent alkyl or alkenyl moieties having from 1 to 12 carbon atoms, aryl moieties, or substituted hydrocarbon moieties, and R′ are alkyl moieties having from 1 to 6 carbon atoms, aryl moieties, or substituted hydrocarbon moieties,
with the proviso that in the case of the functional silanes used in the second reaction step, at least 5% of the moieties R are alkenyl moieties, acyloxyalkyl moieties, mercaptoalkyl moieties, or mixtures thereof.

15. The process of claim 14, wherein the 2nd step is carried out at a temperature of from 15 to 90° C.

16. The process of claim 15, wherein the 2nd step is carried out at a pH of from 1 to 4.

17. The process of claim 14, wherein, after the 2nd step, for application of an inner shell C, mono- and/or polyethylenically unsaturated monomers are fed into the organopolysiloxane core polymer A with a shell composed of polydialkylsiloxane polymer B in an amount such that the proportion of the shell C composed of organopolymer of mono- or polyethylenically unsaturated monomers is at most 89.45% by weight, based on the total weight of the polymer.

18. The process of claim 14, wherein, after the 3rd step, the elastomeric copolymers are isolated from the emulsion by spray drying.
